(19) United States
(12) Patent Application Publication
(10) Pub. No.: US 2025/0005294 A1
(43) Pub. Date: Jan. 2, 2025

(54) SYSTEMS AND METHODS FOR TAILORED RESUME CREATION

(71) Applicant: Best Resume LLC, Lake Oswego, OR (US)

(72) Inventors: Steven Ochs, Beaverton, OR (US); Ryan Layne, Poulsbo, WA (US)

(21) Appl. No.: 18/342,219

(22) Filed: Jun. 27, 2023

(51) Int. Cl. G06F 40/40; G06F 40/166; G06F 40/279; G06N 3/0455

(52) U.S. Cl. CPC G06F 40/40; G06F 40/166; G06F 40/279; G06N 3/0455; G06Q 10/06395; G06Q 10/105

(57) ABSTRACT

The current disclosure provides methods and systems to generate a targeted resume for a description of a job, based on an initial resume of an applicant for the job. In one example, a method for an automated resume generation system includes receiving a job description and a resume of an applicant for the job description; storing individual resume elements of the received resume and job description in a database of the automated resume generation system; submitting each stored individual resume element of the received resume to a selected AI model of a first plurality of AI models, to be rewritten to be tailored to the job description, the selected AI model selected based on the first resume and the job description; validating each rewritten individual resume element using a second plurality of AI models; and generating a targeted resume of the applicant based on the rewritten resume elements.

### TECHNICAL FIELD

Embodiments of the subject matter disclosed herein relate to AI-based content generation, and more particularly, to generating and/or adapting text content of a resume.

### BACKGROUND

Employers may rely at least partially on applicant resumes to analyze a suitability of a candidate for a specific position. It is common for applicants to prepare a targeted resume for the specific position, where the targeted resume is structured and written to maximize the suitability of the candidate for the specific position. Writing a targeted resume may include determining a suitable type and style of resume, suitable language to describe experience of the applicant, identifying ideal keywords to include, aspects, roles, and/or responsibilities of a position to emphasize, and so on. As a result, writing the targeted resume may be difficult, and may rely on skills unrelated to the position, which the applicant may not have developed. Additionally, an applicant may apply for a number of positions, where writing a targeted resume for each position may be time consuming. Current tools available to help applicants write targeted resumes may rely on generic resume templates, keyword stuffing and/or a cumbersome process of manual tailoring, resulting in a lack of customization and adaptability to specific job requirements, inefficient and/or time-consuming processes, and insufficient accuracy under changing job market demands.

### SUMMARY

The current disclosure addresses the issues described above with an artificial intelligence (AI) system, comprising a processor communicably coupled to a non-transitory memory including instructions that when executed, cause the processor to receive a job description and a first resume of an applicant for the job, generate a second, targeted resume of the applicant for the job description based on the first resume using a first plurality of AI models, and display a report including the targeted resume on a display device of the AI system; wherein generating the second, targeted resume further comprises selecting a AI model of the first plurality of AI models, based on the first resume and the job description; inputting an element of the first resume and the job description into the AI model using chained prompts, to generate a respective targeted element; assessing a quality of the targeted element, using a second plurality of AI models; in response to the quality exceeding a threshold quality, including the targeted element in the targeted resume; and in response to the quality not exceeding the threshold quality, using a different AI model of the first plurality of AI models to rewrite the element.

The above advantages and other advantages, and features of the present description will be readily apparent from the following Detailed Description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings in which:

FIG. 1 shows a block schematic diagram of an automated resume generation system, in accordance with one or more embodiments of the present disclosure;

FIG. 2A shows a block schematic diagram of a first workflow carried out by a resume generator of the automated resume generation system, in accordance with one or more embodiments of the present disclosure;

FIG. 2B shows a block schematic diagram of a second workflow carried out by the resume generator, in accordance with one or more embodiments of the present disclosure;

FIG. 3 is a flowchart showing an exemplary high-level method for generating a targeted resume using the resume generator, in accordance with one or more embodiments of the present disclosure;

FIG. 4 is a flowchart showing an exemplary method for pre-processing a resume at a job description submitted to the resume generator, in accordance with one or more embodiments of the present disclosure;

FIG. 5 is a flowchart showing an exemplary method for performing a keyword analysis of a resume, in accordance with one or more embodiments of the present disclosure;

FIG. 6 is a flowchart showing an exemplary AI adjudication process performed by the resume generator to assess the quality of a targeted resume element, in accordance with one or more embodiments of the present disclosure.

FIG. 7 is a flowchart showing an exemplary method for iteratively rewriting resume elements regarding an applicant's work experience, in accordance with one or more embodiments of the present disclosure;

FIG. 8 is a flow chart showing an exemplary method for managing errors generated during a creation of a targeted resume, in accordance with one or more embodiments of the present disclosure;

FIG. 9 shows an exemplary professional summary generated by an AI model for the applicant, including a description of reasoning used by the AI model, in accordance with one or more embodiments of the present disclosure; and

FIG. 10 shows an example of a first resume element describing a work experience of the applicant, and a second, targeted resume element describing the work experience generated by the resume generator, in accordance with one or more embodiments of the present disclosure.

The drawings illustrate specific aspects of the described systems and methods. Together with the following description, the drawings demonstrate and explain the structures, methods, and principles described herein. In the drawings, the size of components may be exaggerated or otherwise modified for clarity. Well-known structures, materials, or operations are not shown or described in detail to avoid obscuring aspects of the described components, systems and methods.

### DETAILED DESCRIPTION

Methods and systems are provided herein for automatically generating a targeted resume of an applicant applying for a job using a plurality of artificial intelligence (AI) models, where the targeted resume is based on an initial resume and a job description supplied by the applicant. The applicant may submit the initial resume and the job description to an automated resume generator, which may be communicatively coupled to a plurality of AI models. The plurality of AI models may include internal models of the AI system described herein, and/or AI models hosted at commercial AI services available to the public. The AI models may include commercial large language models (LLM), such as OPENAI's GPT, natural language processing (NLP) models such as Bidirectional Encoder Representations from Transformers (BERT), or a different deep learning, machine learning, or AI model.

As described in greater detail below, the initial resume may be divided into individual resume elements (also referred to herein as original resume elements) that are stored in a database of the resume generator. The individual resume elements may be pre-processed, formatted, analyzed, and processed by the resume generator to generate a corresponding set of targeted resume elements tailored to the job description. Processing an individual resume element may include submitting the resume element to one or more AI models of the plurality of AI models, which may edit or rewrite the resume element. The one or more AI models may be selected by an AI service optimization model of the resume generator based on the job description. The AI service optimization model may select a most suitable AI model based on the resume element, model pricing, model success rates on similar resume elements or types of resumes, and/or other relevant information.

In some embodiments, when submitting a prompt, a “precontext” may be set when submitting the resume element that may be set to perform a role of a hiring manager for the position described in the job description. Setting the precontext means that the intelligence generated by an AI model may be filtered through a perspective or framework established in the precontext via one or more instructions provided to the AI model. In various embodiments, the precontext may be set prior to submitting one or more prompts. The AI model may then be provided instructions for performing the role of the hiring manager when processing the resume element.

For example, the AI model may be instructed, prior to submitting the prompt, to assume the role of a hiring manager of an engineering project manager. The AI model may be further instructed to review the information presented in the resume element, and establish a plan of action comprising at least two steps prior to taking action on a subsequent prompt. Once the precontext is loaded into the AI model, the subsequent prompt is submitted. By setting an appropriate precontext prior to submitting a resume element to the AI model, a performance of the AI model and an accuracy of a result returned by the AI model may be increased. Specifically, when prompted to establish a multi-step action plan, the AI model may form a strategy for generating desired content, which may result in a higher quality rewritten resume element.

The resume element may be submitted to the most suitable AI model using a series of chained prompts, which may increase an accuracy and/or quality of the targeted resume element. As used herein, accuracy and/or quality refer to a degree of compatibility or calibration with a correlated portion of the job description. The accuracy and/or quality of the targeted resume elements may be analyzed against the original resume elements by a second plurality of AI models, which may compete to assess the quality of the targeted resume elements in an adversarial fashion, with a preferred targeted resume element being selected by a consensus between the second plurality of AI models. If a targeted resume element fails to achieve a threshold quality and accuracy, the preferred targeted resume element may be discarded and a next most suitable AI model may be selected to rewrite the resume element by the AI service optimization model.

In this way, an optimized resume may be iteratively generated from the initial resume with input from various AI models. The optimized resume (e.g., the targeted resume) may be specifically tailored to the job description. For example, the optimized resume may include keywords pertaining to the job description that are more correlated with similar historical applicant-job pairings than the initial resume, and/or may include descriptions of relevant work experience that more closely match job requirements of the job description than initial resume. The resume generator may also generate a professional summary of the applicant that is specifically tailored to the job description.

Additionally, each time a resume element or portion of text extracted from a resume is rewritten by an AI model, the AI model may be prompted to generate a description of reasoning used by the AI model to generate the resume element or portion of text. The description of the reasoning may provide a degree of transparency to the machinations of the AI models, and may indicate why a specific wording of a targeted resume element was selected or why the specific wording of the targeted resume element may represent an improvement over an original wording of the resume element. Also, when prompting the AI model to use a multi-step strategy for rewriting the resume element, the reasoning may be provided for each step of the multi-step strategy, increasing a specificity and quality of the reasoning.

Further, the description of the reasoning may offer additional suggestions regarding how a resume element (e.g., a work experience) may be elaborated upon, for example, to prepare for a job interview. A final report may be provided to the applicant including the targeted resume generated using the resume generation system, where the descriptions of reasoning applied in each of the resume elements may be included inline next to the rewritten (e.g., targeted) resume elements. Including the reasoning in the reports may facilitate educating the applicant with respect to creating a high quality resume for a given job position.

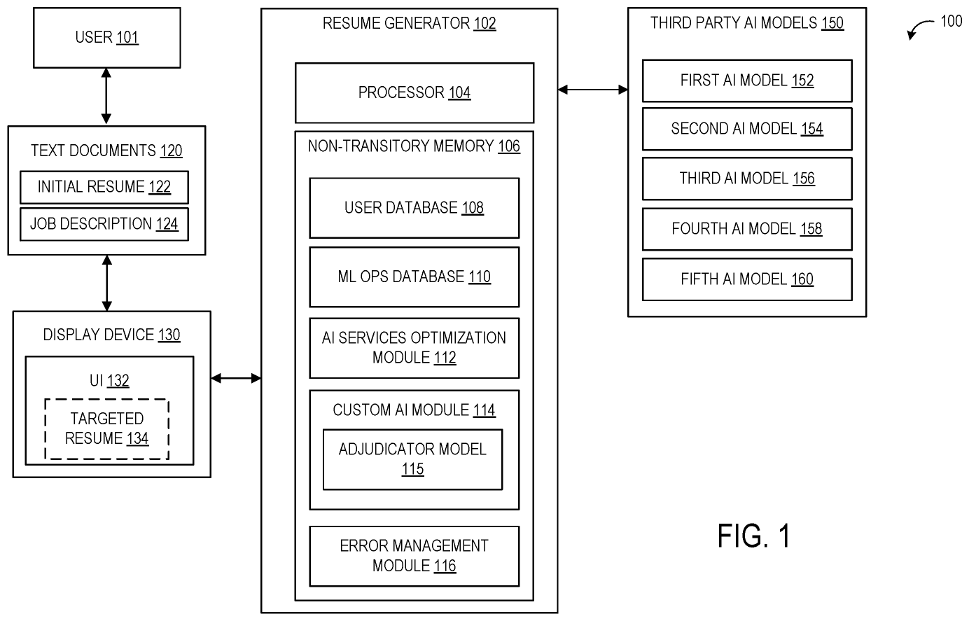

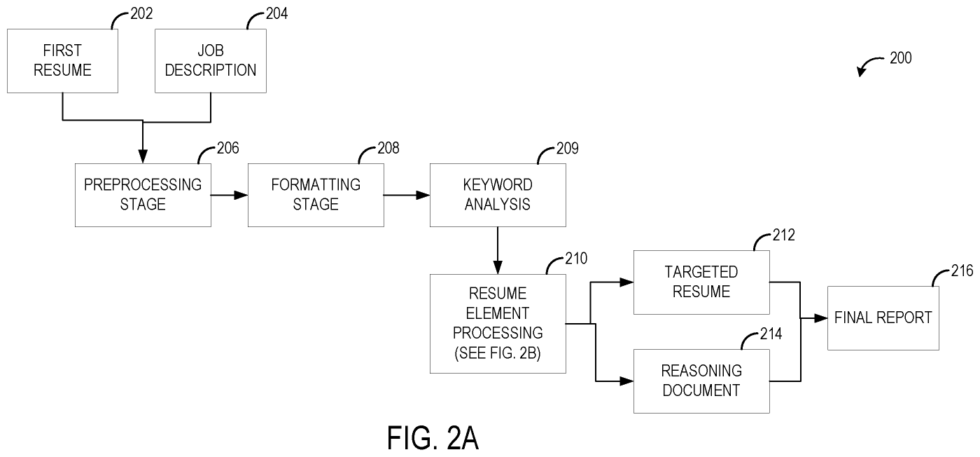

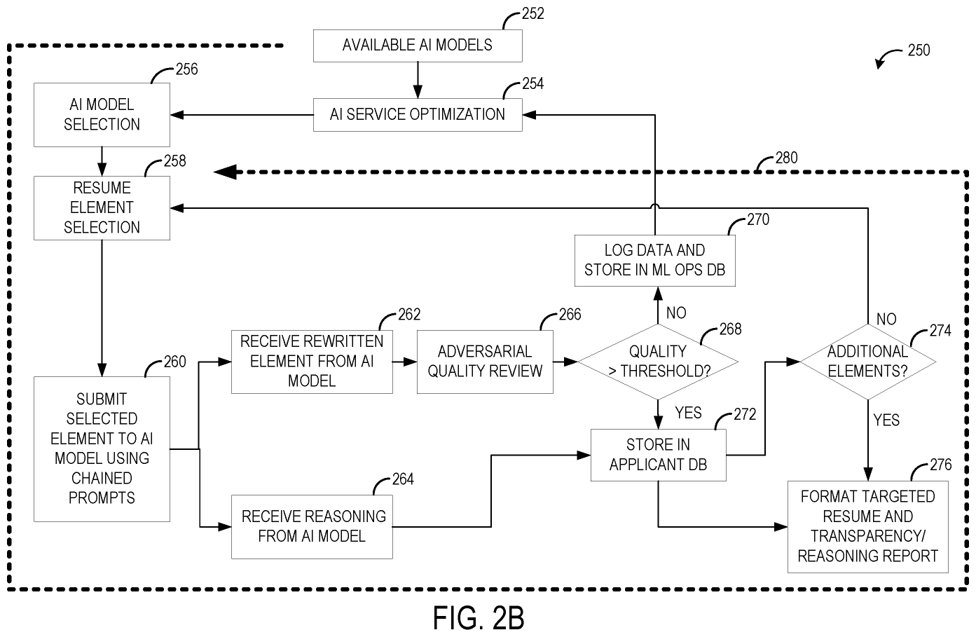

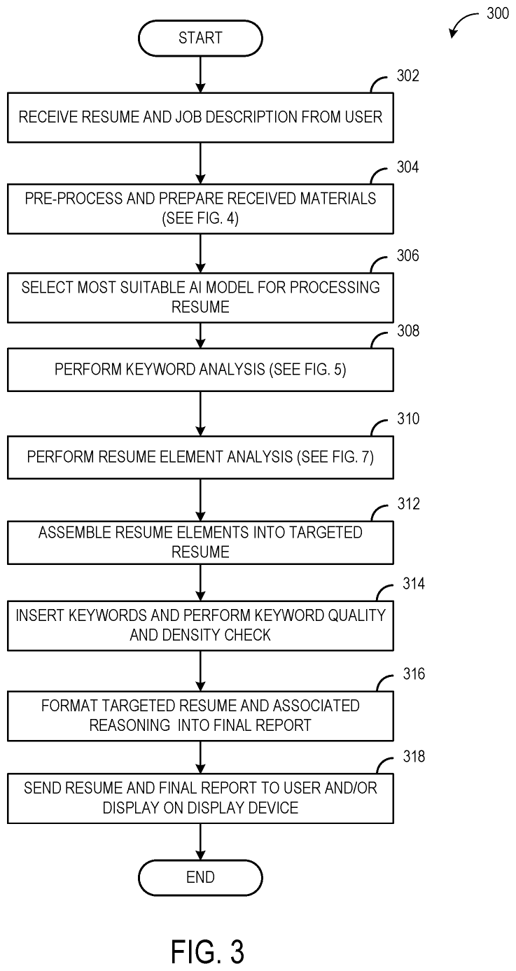

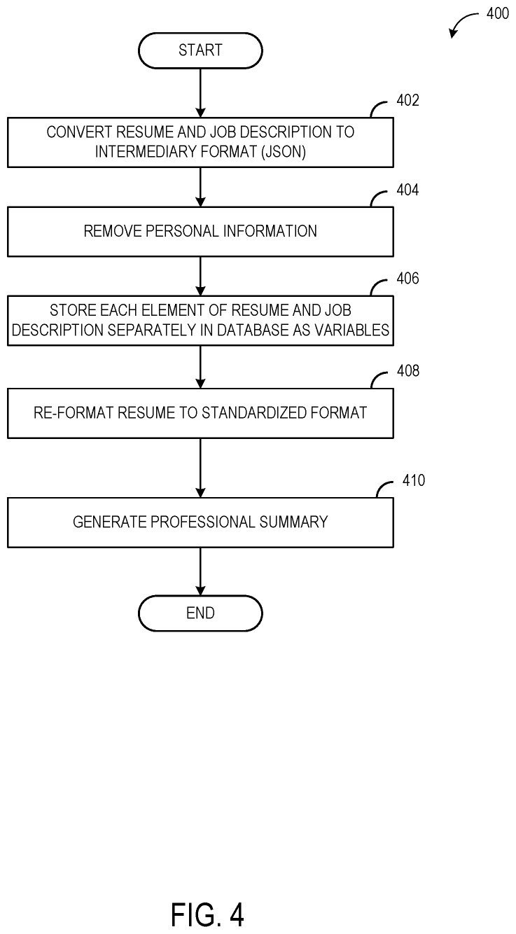

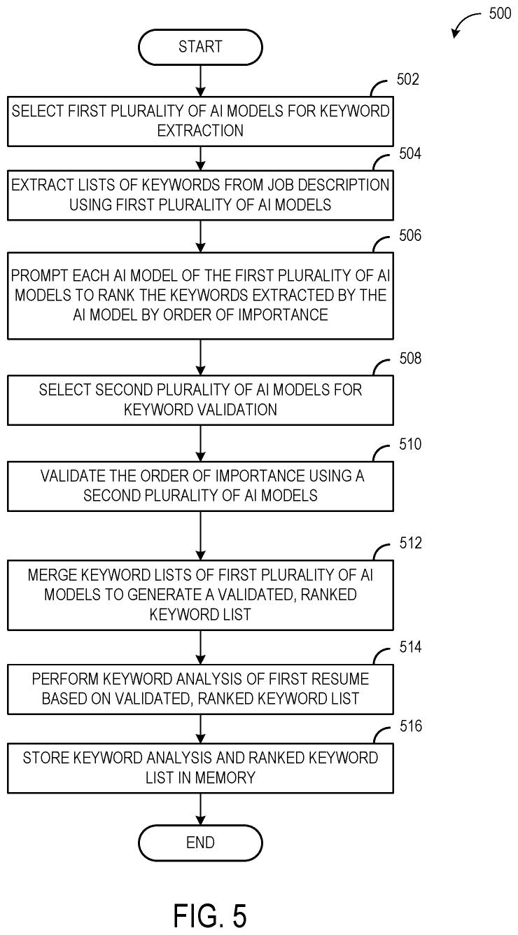

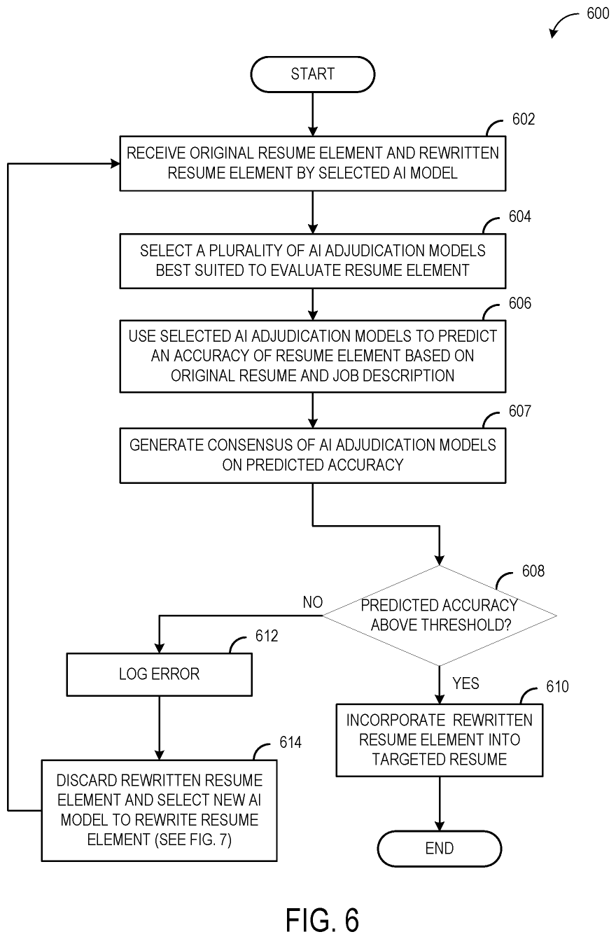

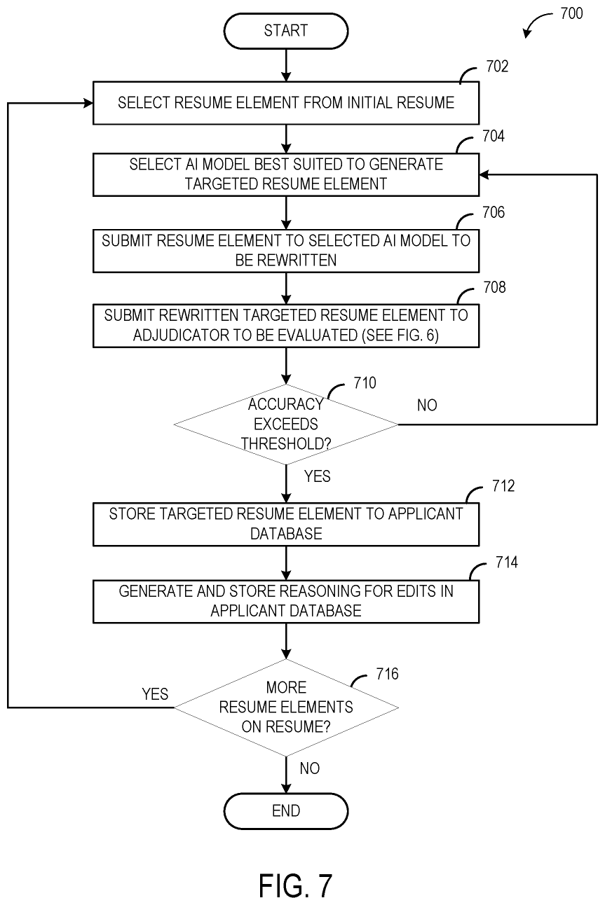

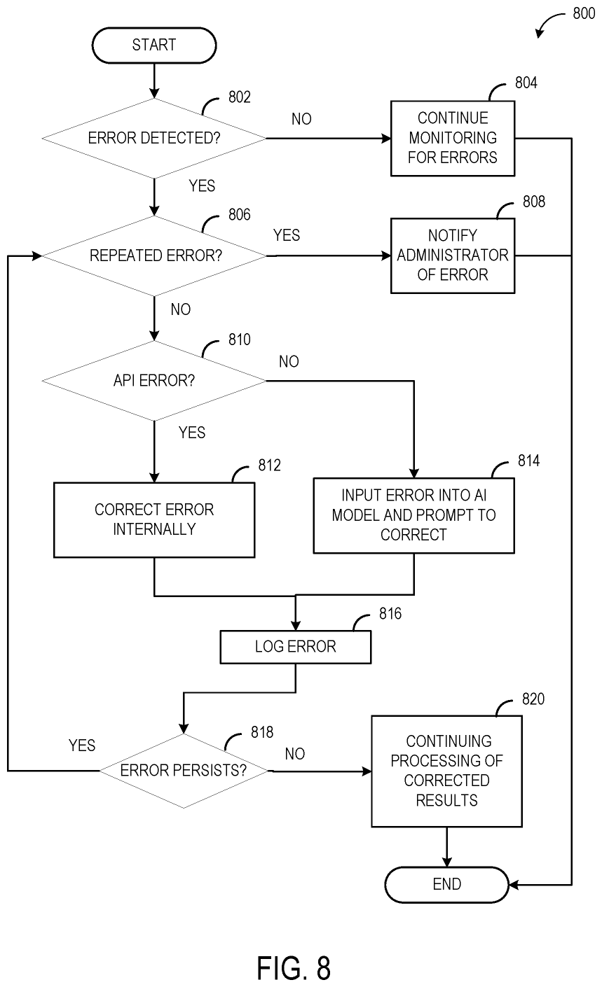

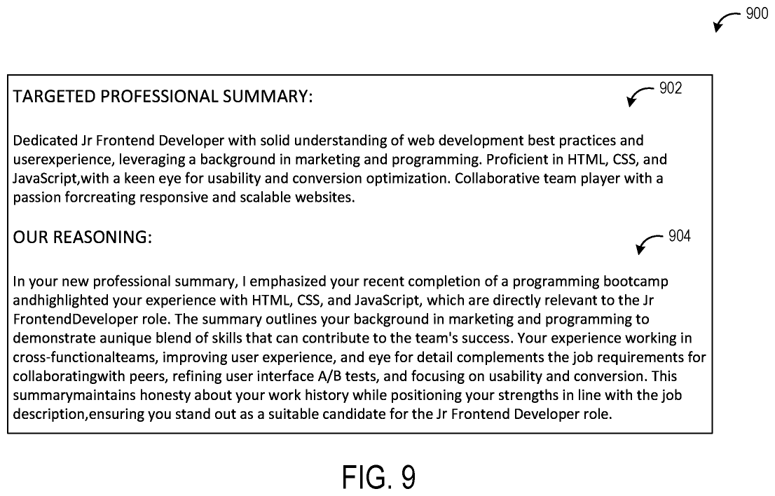

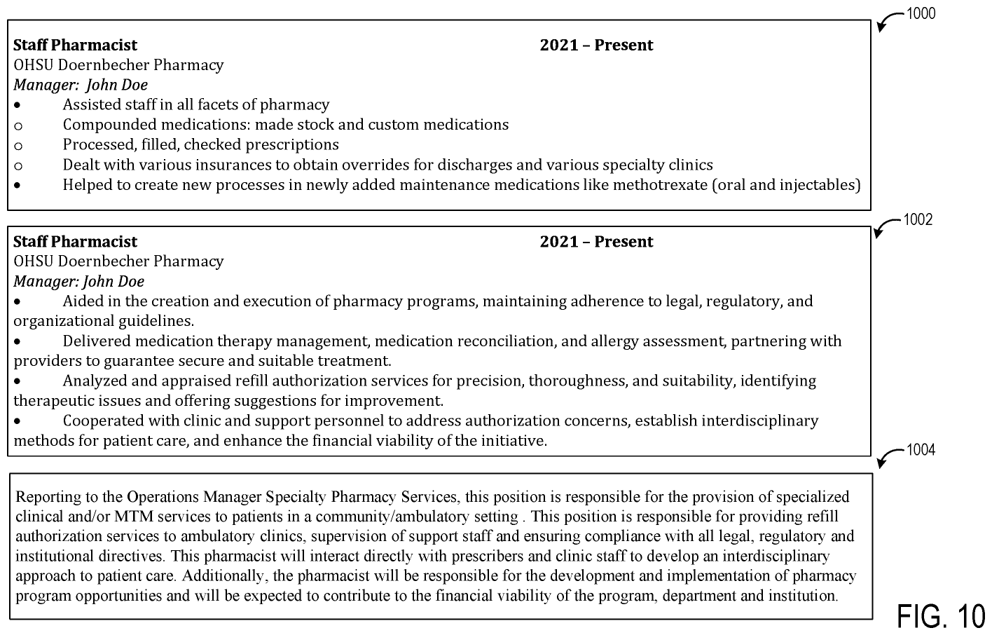

An exemplary resume generation system is shown in FIG. 1. An automated resume generator of the resume generation system may receive a (first) resume and a job description from a user, which may be processed using one or more AI models in accordance with the workflows shown in FIGS. 2A and 2B. Within the workflows, a second, targeted resume may be generated from the first resume by following one or more steps of high-level method shown in FIG. 3. The processing may include a pre-processing stage, as shown in FIG. 4; a keyword analysis stage, as shown in FIG. 5; and a resume element analysis stage, as shown in FIG. 7. A quality of targeted resume elements generated during the processing may be assessed using an AI adjudication process, as shown in FIG. 6. Errors generated by the system during the processing may be processed, corrected by the resume generator internally, logged, stored, and/or used to improve the AI optimization model, as shown in FIG. 8. The processing may include generating a professional summary of the user, an example of which is shown in FIG. 9. An example of a rewritten targeted resume element including a work experience of the user is shown in FIG. 10.

It should be appreciated that while the systems and methods disclosed herein are described with respect to a resume generation system, using the example of generating a targeted resume for a job description given an initial resume, the systems and methods may be more broadly applied to generate text content of a different type. In other words, the systems and methods disclosed herein can be flexibly applied in other cases where text content is desired to be generated based on a “unified documentation blueprint” (e.g., text description of desired text content) and guideline text to be rewritten, edited, and/or used as a model for the desired text content. For example, text content of a company may be rewritten and/or reformatted to adhere to internal style or branding guidelines of the company; editorial content may be rewritten to match a desired editorial style; etc. Further, a general content customization system applicable to a variety of different types of text content is envisioned, which may include customized modules tailored for each type of text content. For example, the general content customization system may include a resume generation module; a style guidelines adherence module; and so on.

FIG. 1 shows an exemplary resume generation system 100, including a resume generator 102 and a plurality of third-party AI models 150. As described in greater detail below, resume generator 102 may follow an automated process to generate a targeted resume tailored to a specific job description inputted into resume generator 102, based on information supplied in one or more text documents 120. In various embodiments, text documents 120 include an initial resume 122, and a job description 124. Text documents 120 may be submitted to resume generator 102 by a user 101, who may be an applicant for a job matching job description 124. In other words, based on initial resume 122 and job description 124, resume generator 102 may generate the targeted resume automatically without additional input by user 101.

Text document 120 may be submitted to resume generator 102 via a user interface (UI) 132 displayed on a display device 130. In some examples, display device 130 may be a display device of resume generator 102 (e.g., a computer screen or display terminal). In other examples, display device 130 may be a computer device of user 101, such as a personal computer, laptop, tablet, smart phone, etc. UI 132 may be generated by resume generator 102, via a standalone application, a web browser, or similar technology. After resume generator 102 has generated a targeted resume 134 from initial resume 122, targeted resume 134 may be displayed in UI 132 on display device 130, where targeted resume 134 may be viewed by user 101.

Resume generator 102 includes a processor 104 and a non-transitory memory 106. Processor 104 may be configured to execute machine readable instructions stored in non-transitory memory 106. Processor 104 may be single core or multi-core, and the programs executed thereon may be configured for parallel or distributed processing. In some embodiments, processor 104 may optionally include individual components that are distributed throughout two or more devices, which may be remotely located and/or configured for coordinated processing. In some embodiments, one or more aspects of processor 104 may be virtualized and executed by remotely-accessible networked computing devices configured in a cloud computing configuration.

Non-transitory memory 106 may store a user database 108, and machine learning (ML) operations database 110, an AI services optimization module 112, a custom AI module 114, and an error management module 116.

Non-transitory memory 106 may include instructions for generating targeted resume 134 from initial resume 122 and job description 124. Specifically, non-transitory memory 106 may include instructions that, when executed by processor 104, cause resume generator 102 to conduct one or more of the steps of method 300 for generating targeted resume 134, described in more detail below in reference to FIG. 3, as well as other methods described herein in reference to subsequent figures.

Targeted resume 134 may be generated using a plurality of AI models, including internal models of the resume generator and/or third-party AI models 150, such as a first AI model 152, a second AI model 154, a third AI model 156, a fourth AI model 158, and a fifth AI model 160. In other embodiments, a greater or lesser number of AI models may be included in third-party AI models 150. The plurality of third-party AI models 150 may include publicly available large language models (LLMs) such as those produced by OPENAI, META AI, AI21, ANTHROPIC, and/or COHERE, or other companies/projects. For example, in one embodiment, first AI model 152 may be a version of GPT (e.g., GPT4 or GPT 3.5 turbo) produced by OPENAI; second AI model 154 may be a version of Jurrassic by AI21; third AI model 156 may be a version of CLAUDE by ANTHROPIC; fourth AI model 158 may be a version of Coral by COHERE; and fifth AI model 160 may be a different AI model offered by a different service. For each of the third-party AI models 150, information about the models may be retrieved or stored that may aid resume generator 102 in determining a most suitable AI model for a given task. The information may include, for example, descriptions of an AI model, a maximum number of tokens accepted by the AI model, training data of the AI model, etc.

Custom AI module 114 may include models of various types, including trained and/or untrained neural networks such as convolutional neural networks (CNNs), recurrent neural networks (RNNs), generative adversarial networks (GANs), or other types of neural networks; statistical models, or other models; and may further include various data, or metadata pertaining to the one or more custom AI models stored therein. Custom AI module 114 may include training datasets for the one or more custom AI models of custom AI module 114. The one or more custom AI models may include, for example, AI models for selecting a suitable AI model of third-party AI models 152 to generate one or more elements of targeted resume 134; AI models for determining an accuracy of the one or more elements of targeted resume 134; AI models for generating a professional summary of the applicant to be included in targeted resume 134; AI models for extracting keywords, job requirements, or other items from initial resume 122 and/or job description 124; or other types of AI models used for different purposes.

In particular, custom AI module 114 may include an adjudicator model 115, which may select, from the one or more custom AI models and/or third party AI models 150, one or more AI models most suitable for assessing a quality or accuracy of resume content generated by the resume generator. An exemplary AI adjudication process used to determine the most suitable one or more AI models is described in greater detail below in reference to FIG. 6.

User database 108 may store text documents 120, including initial resume 122 and job description 124. In particular, user database 108 may store elements of initial resume 122 and/or job description 124 as variables in user database 108. The stored elements of initial resume 122 may include, for example, a professional summary of the applicant, a summary of skills of the applicant, a work experience element of initial resume 122, an educational experience element of initial resume 122, or different type of resume element. The stored elements of job description 124 may include, for example, a job title, required education, required work experience, required skills, etc. User database 108 may also store targeted resume 134 and/or individual elements of targeted resume 134, and/or other information generated by resume generator 102 related to targeted resume 134.

ML operations database 110 may include learning information used to refine or improve one or more ML models of custom AI module 114. ML operations database 110 may include models of various types, including trained and/or untrained neural networks, ML or deep learning (DL) models, statistical models, or other models, and may further include various data, or metadata pertaining to the one or more models stored therein. During generation of targeted resume 134, errors detected in textual content generated by the one or more third-party AI models 150 may be logged to ML operations database 110, and the logged errors may be used to refine or improve the one or more ML models. Instructions for detecting the errors and logging the detected errors in ML operations database 110 may be included in error management module 116. Specifically, error management module 116 may include instructions that when executed by processor 104, perform one or more steps of method 800 of FIG. 8.

In various embodiments, AI services optimization module 112 may include instructions for determining a suitable third-party AI model 150 for editing or rewriting an element of initial resume 122. For example, first AI model 152 may be suitable for editing or rewriting a first element of initial resume 122. Second AI model 154 may be suitable for editing or rewriting a second element of initial resume 122, but may not be suitable for editing or rewriting the first element. Third AI model 156 may be suitable for editing or rewriting a third element of initial resume 122, but may not be suitable for editing or rewriting either of the first element and the second element. Fourth AI model 158 may be suitable for editing the first element, but may not perform as well at editing first model 152 as first AI model 152, and so on. Thus, when rewriting an element of initial resume 122. AI services optimization module 122 may determine a top-performing third-party model 150 to be selected for rewriting the element. One or more models stored in AI services optimization module 122 may be used to determine the top-performing third-party AI model 150. In various embodiments, the top-performing third-party AI model 150 may be selected using a predictive ML model, such as a decision tree model. The top-performing third-party AI model 150 may be selected based at least partially on the information stored about the third-party AI models 150.

FIG. 2A shows a schematic diagram of a first workflow 200 followed by an automated resume generator of a resume generation system, such as resume generator 102 of resume generation system 100 of FIG. 1, to generate, from a first resume submitted by the user of the automated resume generator, a second resume targeted to a specific job description submitted by the user.

First workflow 200 starts when a first resume 202 of an applicant and a job description 204 of a job being applied to by the applicant is received by the automated resume generator. First resume 202 and job description 204 may be non-limiting examples of initial resume 122 and job description 124 of FIG. 1, respectively. A preprocessing stage 206 may first be performed, as described in greater detail below in reference to FIG. 4. After information included in first resume 202 and job description 204 have been preprocessed, a formatting stage 208 may be applied to determine how a targeted resume 212 should be formatted, for example, based on a type of job, industry, applicant, etc. During formatting stage 208, a first formatted version of targeted resume 212 may be generated including various elements of first resume 202. As part of formatting stage 208, some or all elements of first resume 202 may be reordered to generate the first formatted version of targeted resume 212.

A keyword analysis 209 may be performed on the first formatted version, which may identify a preferred set of keywords to use in targeted resume 212 based on job description 204. Keywords from the preferred set of keywords may be incorporated into the elements of first resume 202 during subsequent processing stages. As used herein, processing of a resume or a resume element refers to editing or rewriting the resume or resume element to generate a targeted resume or targeted resume element that is more accurately targeted to the job description.

The elements of the first formatted version of targeted resume 212 may be processed individually in an iterative fashion during a resume element processing stage 210, as described in greater detail below in reference to FIG. 2B. During the resume element processing stage 210, the elements of the first formatted version may be edited and/or rewritten using one or more AI models (e.g., third-party AI models 150 of FIG. 1) to generate targeted resume 212. Additionally, during resume element processing stage 210, a reasoning document 214 may be generated that describes a reasoning used by the one or more AI models to edit and/or rewrite the elements of first resume 202. Reasoning document 214 and targeted resume 212 may be combined in a final report 216, which may be sent back to the applicant.

FIG. 2B shows a schematic diagram of a second workflow 250 followed by an automated resume generator of a resume generation system, such as resume generator 102 of resume generation system 100 of FIG. 1, to generate the targeted resume 212 of FIG. 2A based on an iterative processing of elements of first resume 202. Aspects of second workflow 250 are described in greater detail in the methods of FIGS. 4-8.

Second workflow 250 starts at AI model selection block 256, where an AI model is selected from a plurality of available AI models 252 (e.g., the third-party AI models 150 of FIG. 1). The AI model may be selected from the plurality of available AI models 252 at an AI service optimization block 254, which may determine a most suitable AI model based on first resume 202 and job description 204. In various embodiments, AI service optimization block 254 may rely on a predictive ML model such as a decision tree model, as described above in reference to FIG. 1. The selection of the AI model may be performed by the AI services optimization module 112 of resume generator 102.

After a most suitable AI model has been selected at AI model selection block 256, an element of first resume 202 may be selected at a resume element selection block 258. At a subsequent submission block 260, the selected resume element may be submitted to the AI model using chained prompts, as described in further detail below in reference to FIG. 3. An output 262 of submission block 260 may be a rewritten resume element generated by the AI model. Additional output of submission block 260 may be a description 264 of reasoning employed by the AI model to generate the rewritten resume element (also referred to herein as a targeted resume element).

After receiving the rewritten resume element from the selected AI model, an adversarial quality review 266 may be performed on the resume element. During the adversarial quality review 266, the rewritten resume element may be compared with first resume 202 to check for falsehoods, inaccurate information, missing information, misclassifications, and/or other defects in the rewritten resume element. If information of the rewritten resume element is misstated, the rewritten resume element may be discarded, and a new rewritten resume element may be generated using a different AI model of the available AI models 252.

During the adversarial quality review 266, various AI models of the available AI models 252 may assess a quality of the rewritten resume element in an adversarial fashion, competing as adjudicators, where a quality assessment is generated by a consensus of the adjudicator AI models. The quality assessment may be generated as a result of a series of chained prompts. The chained prompts may be serial prompts, where the rewritten resume element is submitted in parallel to the various models, or sequential prompts, where the quality of the rewritten resume element is assessed over a sequence of prompts where an output of a first prompt is fed into a second prompt of an adjudicator AI model.

In one example, to establish a consensus, the rewritten resume element, the original resume element, and the job description are sent to a plurality of adjudicator AI models (e.g., three AI models). Each adjudicator AI model is prompted to answer a set of Boolean questions, which may collectively be used to determine an accuracy of the rewritten resume element. Exemplary Boolean questions may include questions such as:
“Is the resume element accurate based on the original resume element?”
“Are parts of this sentence that semantically are not true based on the original work experience?”
“Is this sentence a non-action based sentence?”
   If any one of the adjudicator AI models returns a 1 (e.g., false), then the rewritten resume element may be discarded, and a new rewritten resume element may be generated.

If the quality assessment generated by the consensus of the adjudicator AI models is below a threshold quality at a quality determination block 268, data associated with the quality assessment is logged and stored in an ML operations database (e.g., ML operations database 110 of FIG. 1) in an error management block 270. The data may include the AI model used to generate the rewritten resume element and the type of defect, misclassification, omission, etc. detected in the rewritten resume element. The data may be logged and processed by an error management module of the resume generator (e.g., error management module 116 of FIG. 1). The data may be used to increase an accuracy or performance of the AI services optimization performed at AI services optimization block 254 by AI services optimization module 112.

After the data is logged and stored, a different AI model of the available AI models 252 may be selected at AI model selection block 256. The same resume element may be selected at resume element selection block 258, and the different AI model may be used to rewrite the same resume element.

If the consensus that the rewritten resume element is accurate, the rewritten resume element may be stored in an applicant database (e.g., user database 108 of FIG. 1) at a processing block 272. In some examples, the rewritten resume element may also be stored in the ML operations database. Description 264 of the reasoning used to generate the rewritten resume element may also be stored in the applicant database. At a resume completion assessment block 274, a number of remaining resume elements of first resume 202 is determined. If there is at least one additional resume element that has not yet been rewritten, then a next resume element is selected at resume element selection block 258. The next resume element is submitted to the same selected AI model as the previous resume element, as described above. When there are no remaining resume elements of first resume 202, the rewritten resume elements stored in the applicant database may be formatted and incorporated into the targeted resume 212. The descriptions 264 of the reasoning associated with the resume elements may be formatted and incorporated into a transparency/reasoning report (e.g., final report 216), which may be sent to the applicant/user. An exemplary excerpt of the transparency/reasoning report is shown in FIG. 9.

Thus, a processing of each resume element of first resume 202 is performed in a loop 280, where a resume element of first resume 202 is submitted to an AI model to be rewritten at each cycle of loop 280. If a rewritten resume element is below the threshold quality, a different AI model of the available AI models 252 is selected to rewrite the resume element. In this wall, all the resume elements of first resume 202 may be iteratively rewritten, using a first plurality of AI models, the first plurality of AI models including a top performing AI model for each specific resume element, in accordance with the AI service optimization. The AI service optimization is continuously updated for increased performance, based on competing quality assessments performed by a second plurality of AI models, where the second plurality of AI models may include different AI models than the first plurality.

Referring now to FIG. 3, a high level method 300 is shown for generating a second resume of a job applicant from a first resume of the job applicant and a job description using one or more AI models, where the second resume is targeted to the job description. The second, targeted resume may be generated by a resume generator of an automated resume generation system, such as resume generator 102 of resume generation system 100 of FIG. 1. One or more steps of method 300 and the other methods included in this disclosure may be performed by a processor of the resume generator (e.g., processor 104) in accordance with instructions stored in a memory of the resume generator (e.g., non-transitory memory 106). The resume generator may rely on a plurality of third-party AI models, such as third-party AI models 150 of FIG. 1.

Method 300 starts at 302, where the method includes receiving a resume (e.g., the first resume) and a job description from a user of the resume generation system. In various embodiments, the job description and the resume may be received by the resume generator via a user interface displayed in a web browser, as described above referenced FIG. 1. For example, the resume and the job description may be saved as documents, and the documents may be uploaded to the resume generator via the user interface, or the resume and job description may be copied/cut and pasted into the user interface.

At 304, method 300 includes preprocessing and preparing the received materials. Preprocessing and preparing the received materials may include extracting individual elements of the resume and/or the job description and storing the individual elements in a database for processing, as well as other tasks described in greater detail below in reference to FIG. 4.

At 306, method 300 includes selecting a most suitable AI model for processing the resume, based on the job description. As described above in reference to FIG. 2A, the most suitable AI model for processing the resume may be selected from a set of candidate AI models. In particular, the candidate AI models may be internal models of the resume generator, and/or publicly available large language models (LLMs), NLP models, or other models hosted as services by private companies, organizations, or open source projects as described above. In some examples, the internal models may include customized internal versions of the publicly available models. Selecting the most suitable AI model may include using a base AI service application programming interface (API) for the selected AI model. The base AI service API may be used by the resume generator to submit portions of the resume to the selected AI model, and receive corresponding rewritten or edited portions outputted by the selected AI model.

The most suitable AI model may be selected using one or more internal models of the resume generator. The internal models may include predictive ML models, pricing models, statistical models, probabilistic models, belief networks, neural networks, rules-based systems that rely on reference tables stored in memory, or a different type of model. In one embodiment, a random forest model is used to select the most suitable AI model from the set of AI models. In another embodiment, a decision tree model is used to select the most suitable AI model from the set of AI models. For example, various criteria of various different base AI service APIs may be inputted into the random forest or decision tree model to determine a relative suitability of each different AI service. The criteria may include success rates for previous AI models used to process similar types of resumes and/or job descriptions. The criteria may also include per-token pricing or cost data of the AI models; an execution time of the AI models; a current or desired industry of the applicant; whether the applicant is transitioning to a new career field; how frequently the AI model has been selected for use on previous resumes; whether the AI model is an internal or third party AI model; an average number of errors recorded using the AI model over a predetermined time frame (e.g., one day); and/or other information. Based on the information retrieved by the decision tree model, the resume generator may determine a most successful path to a highest-quality resume for a lowest possible cost.

At 308, method 300 includes performing a keyword analysis of the resume (e.g., keyword analysis 209 of FIG. 2A). During the keyword analysis, a set of preferred keywords to be used in the second, targeted resume may be identified and extracted from the job description, using a plurality of AI models that debate accuracy based on the job description via an AI adjudication process. The keywords may include single words, or combinations of two or three words (e.g., key expressions or phrases). The plurality of AI models may be drawn from the set of available AI models described above. The keyword analysis is described in greater detail below in reference to FIG. 5.

At 310, method 300 includes performing a resume element analysis of the resume. During the resume element analysis, individual elements of the resume may be retrieved from an applicant database of the resume generator and submitted to the selected AI model to be rewritten or edited. For example, the resume element may be a work experience element corresponding to a current or previous role or position held by the applicant.

The individual elements may be submitted in an iterative fashion, where a first element of the resume is submitted to the selected AI model to generate a first rewritten element of the targeted resume; a second element of the resume is subsequently submitted to the selected AI model to generate a second rewritten element of the targeted resume; and so on. A quality of each rewritten element of the targeted resume may be assessed via an AI adjudication process similar to that described in reference to FIG. 6. Additionally, when an element of the resume is rewritten by the selected AI model, the selected AI model may also output a description of reasoning used by the selected AI model to generate the rewritten element. The description of the reasoning may be incorporated into a final report delivered to the applicant, which may provide a measure of transparency regarding how the rewritten resume element was generated, in what respects the rewritten element may be preferable to the original element of the resume, and/or how the rewritten element may be strategically referred to or used by the applicant during a job interview. The processing and rewriting of the individual elements of the resume and the incorporation of the reasoning is described in greater detail below, in reference to FIG. 7.

At 312, method 300 includes assembling the targeted resume elements into the targeted resume, including the professional summary. After the targeted resume has been assembled, at 314, method 300 includes inserting keywords generated from the keyword analysis into the targeted resume, and performing a keyword quality and density check of the assembled targeted resume. The keywords may first be retrieved from a memory of the resume generator (e.g., non-transitory memory 106). The assembled targeted resume may then be submitted to an AI model for keyword insertion. The AI model may be one of the first plurality of AI models used to rewrite the resume elements, as described in reference to FIG. 7, or the AI model may be one of the second plurality of AI models used to assess the quality of the rewritten resume elements, as described in reference to FIG. 6, or the AI model may be a different AI model of the available AI models (e.g., third-party AI models 150 and/or custom internal models stored in custom AI module 114 of FIG. 1).

When the assembled targeted resume is submitted to the AI model, the AI model may be prompted to rewrite each resume element of the assembled target resume using the keywords retrieved from the memory. In various embodiments, the AI model may be prompted via a plurality of chained prompts. The AI model may replace one or more words similar to the keywords in each resume element with relevant keywords. In some embodiments, the AI model may add or insert one or more appropriate keywords to the resume element. Additionally, the AI model may be prompted to generate a set of synonyms of the keywords and/or similar words, and add, insert, or replace relevant words of the resume element with the corresponding synonyms and/or similar words. The synonyms may include common synonyms, and/or semantic symptoms.

In various embodiments, the quality of the keywords inserted into a single resume element or the targeted resume as a whole may be assessed by an AI model. The AI model may assess the quality of the keywords in a looping fashion, via a sequence of chained prompts. For example, in a first chained prompt, the AI model may be instructed to replace a plurality of words of a targeted resume element with keywords.

In a second chained prompt, a result of the first chained prompt may be submitted to the AI model, and the AI model may be instructed to perform a quality and density check of the result of the first chained prompt. The keyword quality and density check may be performed in a manner similar to the keyword quality and density check performed on the first resume, as described below in reference to FIG. 5. For example, the keyword quality and density check may calculate a saturation of keywords of the targeted resume, which may be based on a comparison of a number of keywords included in the targeted resume versus a total number of words of the targeted resume, expressed as a percentage. In a third chained prompt, an original resume element corresponding to the targeted resume element may be retrieved from memory (e.g., from user database 108) and submitted to the AI model along with the result of the second chained prompt, and the AI model may be instructed to check to ensure that synonyms of keywords inserted into the resume element do not misclassify or distort the resume element with respect to the original resume element. By chaining the prompts in this manner, the quality of the targeted resume element may be maximized while ensuring a high degree of correspondence with the first resume. If an AI model fails to generate a high quality targeted resume element, or fails to adequately assess the generated targeted resume element, the targeted resume element may be discarded, and a different AI model may be selected to generate a high quality targeted resume element or assess the generated targeted resume element.

After the assembled targeted resume has been rewritten to include the keywords generated from the keyword analysis, a final keyword quality and density check of the assembled targeted resume may be performed. The keyword quality and density check may be performed by a same AI model used to generate and assess the quality of the keywords, or a different AI model. The targeted resume and the first resume may then be compared to generate a benchmark of improvement. The quality and density analysis of the first resume may be retrieved from the memory of the resume generator, and an AI model may perform a comparison of the keyword quality and density of the targeted resume with the keyword quality and density of the first resume. For example, the targeted resume may include a higher keyword saturation/density than the first resume. The target resume may include keywords with a higher degree of relative importance to the job description, for example, based on a semantic similarity method with keyword counts. The benchmark of improvement may be included in a final report generated for the user. The AI model may be an internal AI model of the resume generator, and/or maybe selected from the first or second pluralities of AI models. At 316, method 300 includes formatting the targeted resume, and additionally formatting a final report including the targeted resume and the associated reasoning used by the AI models to generate the targeted resume elements. An excerpt of an exemplary final report is shown in FIG. 9. As part of formatting the targeted resume, personal identifying information of the applicant removed from the resume during pre-processing may be reinserted into the targeted resume.

At 318, method 300 includes sending the resume and the final report to the user, and/or displaying the resume and/or the final report on a display device of the resume generation system, such as display device 130 of FIG. 1. Method 300 ends.

FIG. 4 shows an exemplary method 400 for pre-processing and preparing a resume to be rewritten by a resume generator of a resume generation system including one or more AI models. The resume may be rewritten to be targeted to a job description, where the resume and job description are submitted by the user of the resume generation system (e.g., an applicant for a job). Method 400 may be performed as part of method 300 described above in relation to FIG. 3. It should be appreciated that in some embodiments, one or more steps of method 400 may be performed in a different order.

Method 400 starts at 402, where method 400 includes converting the resume and job description to an intermediary data-interchange format used during processing of the resume. When the resume and job description are converted to the intermediary data interchange format, human-readable text of the resume and job description may be converted to a plurality of data objects (e.g., attribute-value pairs, arrays, etc.) that may be efficiently processed by a software application such as the resume generator. In one embodiment, the intermediary data-interchange format may be a JavaScript Object Notation (JSON) file.

At 404, method 400 includes removing personal identifying information of the applicant from the resume. By removing the personal identifying information of the applicant from the resume, a privacy of the applicant may be maintained. After the resume has been processed and rewritten, the identifying information of the applicant may be inserted into the targeted resume generated by the resume generator.

At 406, method 400 includes storing each element of the resume and each element of the job description in an applicant database (e.g., user database 108) as variables. Storing each element of the resume and job description as variables ensure that no information of the resume may be lost during processing. Additionally, during the processing, each rewritten element of the resume may be compared with the original stored element of the resume to verify accuracy of the rewritten element. In some embodiments, configuration settings and parameters used during one or more steps of the processing of the resume may additionally be stored in the applicant database, to allow for a greater degree of flexibility with respect to configuration of the resume generator.

At 408, method 400 includes reformatting the resume to a standardized format. The standard format may be selected based on one or more preselected resume templates, which in turn may be selected based on aspects of the job description, job title included in the description, an industry of the job, characteristics of the applicant, or other relevant information.

At 410, method 400 includes generating a professional summary for the applicant. In various embodiments, the professional summary may be generated using an internal AI model of the resume generator, which may be stored in a custom AI module of the resume generator such as custom AI module 114 of FIG. 1. The professional summary may be generated by loading a precontext with key job description concepts, such that the AI model becomes a hiring manager assistant based on the job description, and generates an appropriate professional summary of the applicant based on the precontext as described above. If a professional summary of the applicant is already provided in the original resume, the original professional summary may be discarded. An example of a professional summary generated by the resume generator is shown in FIG. 9.

Referring to FIG. 9, a report excerpt 900 of the applicant generated by an AI model the resume generator and/or resume generation system is shown, according to an embodiment. Report excerpt 900 includes an exemplary professional summary 902. Additionally, a description 904 of the reasoning used by the AI model is shown, where description 904 includes various rationalizations of wording choices, keywords, and structure of professional summary 902, which may be helpful to the applicant to understand why professional summary 902 may be helpful to include in a targeted resume.

FIG. 5 shows a method 500 for generating a ranked list of keywords of a job description and performing a keyword analysis of a first resume of an applicant. Method 500 may be performed by a resume generator of a resume generation system, such as resume generator 102 of resume generation system 100 of FIG. 1. The ranked list of keywords may be used to generate a second, targeted resume of the applicant with a preferred set of keywords and/or a larger number of keywords relevant to the job description. The preferred set of keywords may be a set of keywords that more closely matches the job description, which may increase a probability of the applicant being considered for the position referred to in the job description. The keyword analysis may be performed on the first resume as a whole, and/or on individual elements of the first resume. The ranked list of keywords produced using method 500 may be used at various times during processing of the first resume to generate the second, targeted resume, for example, in parts of methods 300 and 700 of FIGS. 3 and 7, respectively. It should be appreciated that method 500 is an exemplary method for illustrative purposes, and in some embodiments, one or more steps of at the 500 may be omitted or performed in a different order.

Method 500 starts at 502, where the method includes selecting a first plurality of AI models for keyword extraction. The first plurality of AI models may be selected by the AI service optimization, as described above in reference to FIG. 2B, where the AI service optimization determines the most suitable set of AI models for extracting keywords from the job description, from a larger set of available candidate AI models. For example, the first plurality of AI models include 2-4 AI models. In various embodiments, the AI service optimization may determine the most suitable set of AI models by comparing a prior performance of each of the available candidate AI models in previous keyword extraction tasks, costs of the different available candidate AI models, processing time of the different candidate AI models, etc.

At 504, method 500 includes extracting lists of keywords from the job description using a first plurality of AI models. Each AI model of the first plurality of AI models may be prompted to output a list of keywords extracted from the job description. For example, a first AI model extract a first list of keywords; a second AI model may extract a second list of keywords, where the second list of keywords may be different from the first list of keywords; a third AI model may extract a third list of keywords, where the third list of keywords may be different from the first and second lists of keywords; and so on.

Extracting the keywords from the job description may include performing an analysis of keywords identified in the job description. The analysis may include calculating a density of the keywords in the job description, and/or determining an importance of each keyword in relationship to the job description. In some embodiments, the importance may be estimated using a semantic similarity method with keyword counts.

At 506, each AI model of the first plurality of AI models may be prompted to rank the keywords of the list generated by the relevant AI model. For example, the first AI model may be prompted to rank the keywords of the first list of keywords; the second AI model may be prompted to rank the keywords of the second list of keywords; the third AI model may be prompted to rank the keywords of the third list of keywords; and so on. In this way, the first plurality of AI models may each generate a ranked list of keywords, where each ranked list may differ slightly from the other ranked lists. For example, a first ranked list may include some keywords that are not included in a second ranked list. Additionally or alternatively, the first ranked list may include the same keywords as the second ranked list, but the first ranked list may rank the keywords of the first ranked list in a different order than the second ranked list.

At 508, the method includes selecting a second plurality of AI models for validating the keywords extracted by the first plurality of AI models. The second plurality of AI models may also be selected by the AI optimization service, based on similar criteria as the first plurality of AI models (e.g., success rates, comparative costs, processing time, etc.). The second plurality of AI models may be different from the first plurality of AI models, or the second plurality of AI models may be the same as the first plurality of AI models. In other words, certain AI models of the available candidate AI models may have a higher performance (in terms of the above criteria) at extracting keywords than ranking keywords, and other AI models of the available candidate AI models may have a higher performance at ranking the keywords then extracting the keywords. In one embodiment, the second plurality of AI models may comprise three AI models.

At 510, method 500 includes validating the ranking (e.g., order of importance) of the lists of keywords generated by the first plurality of AI models. In some embodiments, validating the ranking of the lists of keywords may include prompting each AI model of the second plurality of AI models to rank the lists of keywords in the order of importance, and comparing the outputs of the second plurality of AI models with the original ranked lists outputted by the first plurality of AI models. For example, each AI model of the second plurality of AI models may rank each list of keywords generated by each AI model of the first plurality of AI models, and a consensus may be determined between the AI models of the second plurality of AI models. If the consensus is within a threshold difference with respect to a relevant list of keywords, the relevant list of keywords may be validated. If the consensus is not within the threshold difference of the relevant list of keywords, the relevant list of keywords may not be validated. The consensus may be established based on a unanimous agreement of the AI adjudication models, or a majority rules agreement, or a different algorithm for establishing consensus. An exemplary AI adjudication process that may be used to validate the relevant list of keywords is described below in reference to FIG. 6. At 512, the method includes merging the validated lists of keywords generated by the first plurality of AI models. After the validated list of keywords have been merged, a single set of validated, ranked keywords may be obtained.

In some embodiments, the ranked lists of keywords outputted by the first plurality of AI models may be merged prior to being validated by the second plurality of AI models. An advantage of merging the ranked lists of keywords prior to validation is that a processing time and processing resources consumed while performing method 580 reduced.

At 514, method 500 includes performing a keyword analysis of the first resume, based on the validated, ranked keyword list. Performing the keyword analysis of the first resume may include counting a number of keywords of the validated, right keyword list found in the first resume. Performing a keyword analysis of the first resume may also include calculating a keyword saturation, keyword density, and/or performing a different calculation based on other statistics or metrics, in accordance with various algorithms known in the art.

At 516, at the 500 includes storing the keyword analysis of the first resume and the validated, ranked keyword list in a memory of the resume generator (e.g., non-transitory memory 106 of FIG. 1). The keyword analysis of the first resume may be compared with a second keyword analysis of a second resume generated by the resume generator, to estimate a degree of improvement of the second resume with respect to the first resume. The ranked keyword list may be used in various stages of processing the first resume to generate the second resume. For example, keywords from the ranked keyword list may be inserted into resume elements of the second resume by the resume generator, as described in greater detail in reference to FIGS. 3 and 7. Method 500 ends.

FIG. 6 shows an exemplary method 600 for an adversarial AI adjudication process for determining an accuracy and/or quality of a targeted resume element generated by an AI model, based on a corresponding resume element extracted from an original resume (e.g., initial resume 122) submitted by an applicant to a resume generation system, such as resume generation system 100 of FIG. 1. The accuracy and/or quality of the targeted resume element may be assessed based on the original resume and a job description submitted to the resume generation system (e.g., job description 124). In the AI adjudication process, a plurality of AI adjudication models may each assess the quality of the targeted resume element, and the quality assessments may be used to determine whether to discard the targeted resume element or include the targeted resume element in a final targeted resume. The plurality of AI adjudication models may be the same as a plurality of AI models used to generate the targeted resume element (e.g., internal AI models of the resume generator and/or third-party AI models 150 of FIG. 1), or the plurality of AI adjudication models may include a greater and/or lesser number of and models and/or different AI models than the plurality of AI models used to generate the targeted resume element. In some embodiments, a similar AI adjudication process may be used to validate an accuracy and/or relative importance of one or more keywords extracted from the job description, as described above in reference to method 500 of FIG. 5.

Method 600 begins at 602, where method 600 includes receiving a job description and an original resume element extracted by the resume generator from the original resume (e.g., first resume 202 of FIG. 2A). As described above in reference to FIG. 3, the original resume elements may be extracted from the original resume and stored in a database (e.g., user database 108 of FIG. 1), and iteratively processed by the resume generator in accordance with the 300 of FIG. 3.

At 604, the method includes selecting a plurality of AI adjudication models from a plurality of candidate AI models. The plurality of candidate AI models may include one or more internal models of the resume generator (e.g., stored in custom AI module 114 of resume generator 102) and/or one or more third-party AI models, such as third-party AI models 150 of resume generation system 100. In various embodiments, the plurality of AI adjudication models may be selected by an AI adjudicator model (also referred to herein as the adjudicator), such as adjudicator model 115 of resume generator 102. In one example, the plurality of AI adjudication models includes 3 AI adjudication models. In other examples, the plurality of AI adjudication models may include a smaller or greater number of AI adjudication models. The plurality of AI adjudication models may be selected based on suitability predictions made by the adjudicator. The adjudicator may predict the most suitable AI models of the available candidate AI models to use to assess the accuracy and/or quality of the received rewritten resume element. For example, the adjudicator may estimate a performance of each AI model of the available candidate AI models at assessing the accuracy and/or quality of the received rewritten resume element, based on a series of criteria. The criteria may be predetermined or the criteria may be learned by the adjudicator. The adjudicator may be or include various types of models, such as neural network models, statistical models, probabilistic models, belief networks, expert systems or rules-based models etc.

In one embodiment, the adjudicator may assign performance scores to the available candidate AI models, and select the plurality of AI adjudication models based on the assigned performance scores. For example, the performance scores a range from 1 to 10, and candidate AI models having performance scores equal or greater to eight may be selected as the plurality of AI adjudication models.

Various criteria may be used to select the plurality of AI adjudication models. The criteria may include a type of the received resume element. For example, a first candidate AI model may be more suitable for assessing the quality of a resume element corresponding to an educational experience than a work experience of the applicant, while a second candidate AI model may be more suitable for assessing the quality of a resume element corresponding to a work experience than an educational experience of the applicant.

The criteria may also include a current industry of the applicant, and a desired industry of the applicant, which may be different from the current industry, if the applicant is changing jobs. Some AI models may be better suited to certain fields than other fields.

The criteria may also include an estimated reliability of an AI model of performing a quality assessment task. For example, the estimated reliability may be based on a number of errors logged with respect to the AI model over a predetermined amount of time, such as a day. Other criteria may also be included, such as a number of tokens included in the resume element (e.g., an overall number of characters), a cost of using the AI model per token, an estimated amount of time taken to execute the quality assessment by the AI model, whether the AI model is an internal model or a third-party model, and/or other criteria.

Selecting the AI adjudication model may include setting a base AI service application programming interface (API) for the selected AI adjudication model. The base AI service API may be used by the resume generator to submit the targeted resume element to a selected AI adjudication model, and receive a corresponding quality assessment of the targeted resume element outputted by the selected AI adjudication model.

At 606, the method includes using the selected AI adjudication models to predict the accuracy and/or quality of the rewritten (e.g. targeted) resume element, based on the job description. The accuracy and/or quality of the rewritten resume element may be predicted by each AI adjudication model based on the criteria mentioned above. In some embodiments, sentence embedding-based methods such as Sentence-BERT (SBERT) may be used to assess the accuracy and/or quality of the rewritten resume element. When the embedding-based methods are used, a first sentence of the job description or original resume element may be converted into a first vector of values, and compared to a second vector of values similarly generated from a second sentence of the targeted resume element. A comparison score may be generated, which may be used to predict the accuracy of the targeted resume element.

At 607, the method includes generating a consensus of the AI adjudication models with respect to the predicted accuracy. In one embodiment, the consensus may be based on each AI adjudication model of the plurality of AI adjudication models outputting a predicted accuracy/quality within a threshold difference of the other AI adjudication models of the plurality of AI adjudication models, where the predicted accuracies additionally exceed a predetermined threshold. For example, a first AI adjudication model may output a first predicted accuracy of the rewritten resume element; a second AI adjudication model may output a second predicted accuracy of the rewritten resume element; and a third AI adjudication model may output a third predicted accuracy of the rewritten resume element. If any one of the first, second, and third AI adjudication models output a predicted accuracy of the rewritten resume element below the threshold accuracy, the rewritten resume element may not be accepted. Alternatively, if all of the first, second, and third AI adjudication models output a similar predicted accuracy of the rewritten resume element above the threshold accuracy, the rewritten resume element may be accepted. In other embodiments, a variation or different procedure for determining a consensus may be used.

At 608, the method includes determining whether the predicted accuracy determined by consensus is greater than a threshold accuracy. Determining whether the predicted accuracy is greater than the threshold accuracy may include prompting the AI adjudication models with a series of boolean questions, all of which must be true to pass.

If at 608 the predicted accuracy exceeds the threshold accuracy, method 600 proceeds to 610. At 610, the method includes incorporating the rewritten resume element into the targeted resume, and method 600 ends. Alternatively, if at 608 the predicted accuracy is below the threshold accuracy, method 600 proceeds to 612. At 612, method 600 includes logging an error. The error may be logged by an error management system of the resume generation system (e.g., error management module 116), as described in greater detail in reference to FIG. 8. The logged error may be saved in an ML operations database (e.g., ML operations database 110) and used to increase a performance of an AI service optimization model used to select one or more AI models used to rewrite elements of the original resume, as described above in reference to FIG. 2B.

At 614, the method includes discarding the rewritten resume element and selecting a new AI model to rewrite the resume element. In this way, method 600 may iterate or loop through a plurality of AI models selected by the AI optimization service to rewrite the resume element, starting with a predicted top-performing AI model, and assess the output of the selected AI model by consensus using the AI adjudicator models. If the predicted top-performing model is rejected by the AI adjudicator models and discarded, a next best performing AI model is selected, until a rewritten resume element with an acceptable quality is generated, and method 600 ends.

Referring now to FIG. 7, an exemplary method 700 is shown for generating a targeted resume element corresponding to a selected resume element of an initial resume submitted by the applicant to a resume generator of a resume generation system, such as resume generation system 100 of FIG. 1. Method 700 may be performed as part of method 300 described above in reference to FIG. 3.

Method 700 begins at 702, where the method includes selecting a resume element from the resume. The resume element may be retrieved from an applicant database of the resume generator (e.g., user database 108).

At 704, method 700 includes selecting a most suitable AI model for rewriting the selected resume element, as described above in reference to the 300 of FIG. 3. The most suitable AI model may be selected by one or more optimization models included in an AI services optimization module, such as AI services optimization module 112 of resume generator 102 of FIG. 1.

At 706, method 700 includes using the selected AI model to rewrite the selected resume element. Using the selected AI model to rewrite the selected resume element may include submitting the selected resume element and the job description to the selected AI model, and prompting the selected AI model to rewrite the selected resume element in a series of chained prompts.

For example, in a first chained prompt, the AI model may be instructed to rewrite the selected resume element, based on the job description. The first chained prompt may include specific instructions regarding how the rewritten resume element should be structured. The first chained prompt may include specific instructions describing a desired style of the rewritten resume element, such as, for example, a length and/or number of sentences to include, or a desired syntax to be used in the sentences. For example, the AI model may be instructed to rewrite senses in an action-result format.

The first chained prompt may also include or reference data structures included in the first chained prompt, which may be used in subsequent prompts. For example, a taxonomy may be defined in the first chained prompt, and the first chained prompt include instructions to insert text generated for the rewritten resume element into the taxonomy for subsequent processing. During the subsequent processing, operations may be performed on or using the taxonomy. For example, a job taxonomy include categories of different jobs, where the AI model may use the job taxonomy to determine whether the applicant may be transitioning from a first career field to a second career field. The first chained prompt may additionally provide context information, further guidelines, and/or instructions regarding how specific information should be processed and/or stored. The first chained prompt may include instructions to provide a reasoning of the AI model in generating the output of the first chained prompt.

In a second chained prompt, a result of the first chained prompt may be submitted to the AI model, and the AI model may be further instructed to refine the output of the first chained prompt. For example, the second chained prompt may request that the AI model further examine portions of the output of the first chained prompt, or compare portions of the output of the first chained prompt with the job description for accuracy. The second chained prompt may also include instructions to provide a reasoning of the AI model in generating the output of the second chained prompt.

In a third chained prompt, a result of the second chained prompt may be submitted to the AI model, and the AI model may be further instructed to insert and/or replace words of the rewritten resume element outputted by the second chained prompt with keywords selected from a keyword analysis of the job description (e.g., keyword analysis 209 of FIG. 2A). The third chained prompt may include further instructions to incorporate appropriate synonyms of the keywords. The third chained prompt may include instructions to provide a reasoning of the AI model in generating the output of the third chained prompt.

In a fourth chained prompt, an original resume element corresponding to the targeted resume element may be retrieved from memory (e.g., from user database 108) and submitted to the AI model along with the result of the third chained prompt, and the AI model may be instructed to compare the original resume element with the rewritten resume element and evaluate an improvement of the rewritten resume element over the original resume element. For example, the AI model may be instructed to ensure that synonyms of keywords inserted into the rewritten resume element do not misclassify or distort the meaning of the original resume element. The fourth chained prompt may include instructions to provide a reasoning of the AI model in generating the output of the fourth chained prompt.

By chaining the prompts in this manner, the quality of the rewritten resume element may be ensured while simultaneously ensuring that the targeted resume element is compatible with the original resume element. As with the keyword analysis described above, if the AI model fails to generate a high quality rewritten resume element, the rewritten resume element may be discarded, and a different AI model may be selected to rewrite the original resume element.

An additional advantage of using chained prompts is that a reasoning used by the AI model may be broken down into individual components, where different reasoning used by the AI model at each chained prompt may be combined into an overall expression of the AI model's reasoning during generation of the rewritten resume element. The overall expression may be more detailed and/or accurate than if the AI model were provided instructions in a single prompt, without using prompt chaining.

Additionally, as described above, prior to submitting one or more chained prompts, a precontext may be set that specifies a context for performing tasks included in the prompts. The precontext may specify, for example, that the AI model act as a hiring manager and formulate a multi-step action plan (e.g., a strategy) for rewriting the resume element. Prompting the AI model to formulate the multi-step strategy may result in a rewritten (targeted) resume element of higher quality than an alternative target resume element rewritten without prompting the AI model to formulate the multi-step strategy. The AI model may then be prompted to provide reasoning for each step of the multi-step action plan. By providing the reasoning for each step of the multi-step action plan, an overall coherence of the reasoning may be improved, generating higher quality reasoning.

At 708, method 700 includes submitting the rewritten resume element to the adjudicator to be evaluated for accuracy. In various embodiments, the accuracy of the rewritten resume element may be assessed by following an AI adjudication process, such as the AI adjudication process described above in reference to FIG. 6.

At 710, method 700 includes determining whether the accuracy of the rewritten resume element exceeds a threshold accuracy, as determined by the AI adjudication process. If at 710 it is determined that the accuracy exceeds the threshold accuracy, method 700 proceeds to 712. At 712, method 700 includes storing the rewritten resume element to an applicant database of the resume generator (e.g., user database 108). At 714, method 700 includes generating and storing a description of reasoning used by the AI model in rewriting the resume element in the applicant database, and method 700 proceeds to 716. The description of the reasoning used by the AI model may include reasoning generated by the AI model with respect to tasks performed a plurality of chained prompts, as described above.

If at 710 it is determined that the accuracy of the rewritten resume element (e.g. the targeted resume element) does not exceed the threshold accuracy, method 700 proceeds back to 704, where a next available AI model is selected to rewrite the resume element.

At 716, method 700 includes determining whether there are additional resume elements in the resume (e.g., in the applicant database). If there are additional resume elements in the resume, method 700 proceeds back to 702, and a next resume element is selected from the applicant database corresponding to the initial resume. Alternatively, if no additional resume elements are left on the resume, method 700 ends.

An example of an original resume element corresponding to a work experience of the applicant and a rewritten work experience are shown in FIG. 10.

Referring to FIG. 10, an original resume element 1000 is shown alongside a targeted resume element 1002 and a job description 1004, where targeted resume element 1002 was rewritten based on original resume element 1000 by a resume generator, such as resume generator 102 of FIG. 1. In particular, targeted resume element 1002 is generated by submitting job description 1004 and original resume element 1000 to one or more of a plurality of AI models communicatively coupled to the resume generator, and including instructions for rewriting original resume element 1000 to be targeted to job description 1004 via a series of chained prompts. In comparison to original resume element 1000, targeted resume element 1002 includes a greater number of keywords (including synonyms) found in job description 1004, and targeted resume element 1002 may be more tailored to job description 1004. It should be appreciated that while original resume element 1000 is a work experience item of a resume, similar examples may be generated for educational experience, professional summaries, and/or other elements of a resume.

Turning now to FIG. 8, an exemplary method 800 is shown for handling errors detected during processing of a resume by a resume generator of a resume generation system, such as resume generator 102 of resume generation system 100 of FIG. 1. In various embodiments, the errors may be detected by an error management module of the resume generator, such as error management module 116.

At 800 begins at 802, where the method includes determining whether an error is detected. The error may be detected during any stage in the processing of the resume, including preprocessing and preparing the resume as described in reference to FIG. 4; performing a keyword analysis of a resume element of the resume, a targeted resume element generated from the resume element, and/or a job description used to generate the targeted resume element, as described in reference to FIG. 5; performing a resume element analysis, as described in reference to FIG. 7; evaluating quality of a rewritten resume element, as described above in reference to FIG. 6; and/or during other processing tasks, such as when inserting keywords, performing keyword quality and density checks, formatting a targeted resume, etc. Various different kinds of errors may be detected. For example, the errors may include missing data or inclusion of odd characters; parsing or validation errors; formatting errors; errors returned from an API associate with an AI model used for processing the resume; or a different kind of error.

If at 802 an error is not detected, method 800 proceeds to 804, where method 800 includes continuing to monitor for errors, and method 800 ends. Alternatively, if an error is detected at 802, method 800 proceeds to 806.

At 806, method 800 includes determining whether the error is a repeated error. The repeated error may be an error that occurs more than a threshold number of times, where the threshold number may be determined by a customizable parameter. In one embodiment, the threshold number may be two, where a repeated error may be an error that occurs more than twice, e.g., after two subsequent attempts to correct the error. If at 806 it is determined that the error is a repeated error, method 800 proceeds to 808. At 808, method 800 includes notifying an administrator of the resume generation system, and method 800 ends.

Alternatively, if the error is not a repeated error, method 800 proceeds to 810. At 810, method 800 includes determining whether the error is an error returned by an API of an AI service for an AI model used for processing the resume. If it is determined at 810 that the error is an API error, method 800 proceeds to 812.

At 812, method 800 includes correcting the error internally. The error may be corrected internally via various models and/or algorithms included in the error management module. Correcting the error may include finding and inserting or otherwise handling missing or invalid data; removing any odd characters; resolving any parsing or validation errors; fixing a formatting of a job description, targeted resume element, or targeted resume, for example, to address errors in sentence structure, keyword saturation, and core concepts of a job description; and/or other tasks. In some cases, correcting the error may include correcting errors generated by lower-level AI model API calls that may fail during a use of the AI model, which may be less computationally expensive than addressing higher-level AI model errors. Additionally, correcting the error may include determining whether a selected resume format is appropriate for an industry of the job description, and/or identifying industries that have a specific resume format, and switching to the specific resume format.

After the error is corrected, method 800 proceeds to 816. At 816, method 800 includes logging the error. Logging the error may include storing information of the error in a database of the resume generator, such as the ML operations database 110 of FIG. 1. The stored error information may be used to increase a performance of the resume generation system.

Returning to 810, if it is determined that the error is not an API error, method 800 proceeds to 814. At 814, method 800 includes inputting the error or information of the error into an AI model, and prompting the AI model to correct the error. After attempting to correct the error, method 800 proceeds to 816, and the error is logged.

At 818, method 800 includes determining whether the error persists. If the error is persistent and still occurs, method 800 proceeds back to 806, where it is determined whether an administrator should be notified. Alternatively, if at 818 it is determined that the error has been resolved, method 800 proceeds to 820.

At 820, method 800 includes continuing processing of the corrected results, and method 800 ends.

Thus, an automated text generation system is provided for rewriting a first document (e.g., text content) based on information provided in a second document, such that the first document is targeted to meet a set of guidelines established in the second document. The automated text generation system may be a resume generation system, where the first document is a resume, and the second document is a job description to which the resume is rewritten to be targeted to. The resume generation system may rely on a plurality of AI models, where a first set of AI models may compete to write a highest-quality revision of the resume, and a second set of AI models may evaluate the quality of the resume. The second set of AI models may use a consensus-based procedure for evaluating the quality of the resume. The resume, or text content, may be iteratively rewritten section by section, where each section may be written by a different AI model. The sections may be combined to generate the highest-quality revision of the resume. A report may be generated including the highest-quality revision, and the report may include a reasoning of the AI models used to generate each section. In this way, a user may read the report to see how the resume was improved by the AI models. By using the automated resume generation system to rewrite the resume, a targeted resume may be generated that more closely matches the job description than the original resume. A user of the automated resume generation system may use the targeted resume to apply for a position of the job description, and as a result of using the targeted resume rather than the original resume, a probability of the user of getting the job and/or interviewing for the job may be increased.

The technical effect of using the automated resume generation system to rewrite the resume based on the job description is that the rewritten resume may be more closely tailored targeted the job description than the original resume, leading to a higher probability of getting the job.

The disclosure also provides support for an automated resume generation system, comprising: a resume generator including a processor communicably coupled to a non-transitory memory including instructions that when executed, cause the processor to receive a job description and a first resume of an applicant for the job, generate a second, targeted resume for the job description based on the first resume using a first plurality of artificial intelligence (AI) models, and display the targeted resume on a display device of the AI system, wherein generating the second, targeted resume further comprises: selecting an AI model of the first plurality of AI models, based on the first resume and the job description, inputting an original resume element of the first resume and the job description into the AI model using chained prompts, to generate a respective targeted resume element, and including the targeted resume element in the targeted resume. In a first example of the system, further instructions are stored in the non-transitory memory that when executed, cause the processor to assess a quality of the targeted resume element, using a second plurality of AI models, in response to the quality exceeding a threshold quality, including the targeted resume element in the targeted resume, and in response to the quality not exceeding the threshold quality, selecting a different AI model of the first plurality of AI models to rewrite the resume element. In a second example of the system, optionally including the first example, the second plurality of AI models compete to assess the quality of the targeted resume element against the original resume element in an adversarial fashion, with the quality being determined by a consensus between the second plurality of AI models. In a third example of the system, optionally including one or both of the first and second examples, the first and second pluralities of AI models include at least one of: internal AI models of the resume generator, large language models (LLM) available via public AI services, and natural language processing (NLP) models available via public AI services. In a fourth example of the system, optionally including one or more or each of the first through third examples, the first plurality of AI models is different from the second plurality of AI models. In a fifth example of the system, optionally including one or more or each of the first through fourth examples, the second, targeted resume includes a professional summary generated by an AI model of the first plurality of AI models, the professional summary based on the first resume and the job description. In a sixth example of the system, optionally including one or more or each of the first through fifth examples, further instructions are included in the non-transitory memory that when executed, cause the processor to further prompt the AI model to generate a textual description of reasoning used by the AI model to generate the targeted element. In a seventh example of the system, optionally including one or more or each of the first through sixth examples, further instructions are stored in the non-transitory memory that when executed, cause the processor to: generate a report including the targeted resume and the textual description of the reasoning used by the AI model, and display the report on a display device of the resume generation system and/or send the report to the applicant. In a eighth example of the system, optionally including one or more or each of the first through seventh examples, the suitable AI model of the first plurality of AI models is selected using an AI service optimization model based on at least one of: the first resume, a pricing of AI services including the AI models, and a success rate of an AI model on similar types of resumes. In a ninth example of the system, optionally including one or more or each of the first through eighth examples, the AI service optimization model includes a predictive machine learning (ML) model. In a tenth example of the system, optionally including one or more or each of the first through ninth examples, further instructions are stored in the non-transitory memory that when executed, cause the processor to perform a keyword analysis of a portion and/or all of the targeted resume. In a eleventh example of the system, optionally including one or more or each of the first through tenth examples, the keyword analysis includes: using the first plurality of AI models to extract a respective plurality of lists of keywords from the job description, prompting each AI model of the first plurality of AI models to rank the list of keywords extracted by the AI model by order of importance, using the second plurality of AI models to validate the order of importance of each list of keywords, merging the list of keywords extracted by the first plurality of AI models to generate a validated, ranked keyword list, performing a keyword quality and density analysis of the portion and/or all of the targeted resume based on the validated, ranked keyword list, and storing a result of the keyword quality and density analysis in a memory of the resume generator and/or displaying the keyword quality and density analysis on a display device of the resume generation system.

The disclosure also provides support for a method for an automated resume generation system, the method comprising: receiving a job description, receiving a resume of an applicant for the job description, storing individual resume elements of the received resume and job description in a database of the automated resume generation system, submitting each stored individual resume element of the received resume to a selected AI model of a first plurality of AI models, to be rewritten to be tailored to the job description, the selected AI model selected based on the first resume and the job description, validating each rewritten individual resume element using a second plurality of AI models, generating a targeted resume of the applicant based on the rewritten individual resume elements, and displaying the targeted resume on a display device of the automated resume generation system and/or sending the targeted resume to the applicant. In a first example of the method, the method further comprises: submitting each stored individual resume element to the selected AI model in a sequence of chained prompts. In a second example of the method, optionally including the first example, validating each rewritten individual resume element using the second plurality of AI models further comprises: submitting the rewritten individual resume element to each AI model of the second plurality of AI models, and prompting each AI model to answer an identical plurality of questions with Boolean responses, in response to all of the second plurality of AI models returning true to all of the plurality of questions, including the rewritten individual resume element in the targeted resume, and in response to any of the second plurality of AI models returning false to a question of the plurality of questions, discarding the rewritten individual resume element and submitting the stored individual resume element to a different AI model of the first plurality of AI models to rewrite the resume element. In a third example of the method, optionally including one or both of the first and second examples, the targeted resume includes a professional summary generated by an AI model of the resume generator, the professional summary targeted to the resume and the job description. In a fourth example of the method, optionally including one or more or each of the first through third examples, displaying the targeted resume on the display device of the automated resume generation system and/or sending the targeted resume to the applicant further comprises including the targeted resume in a report, the report including a textual description of a reasoning used by the selected AI model, the textual description generated by the selected AI model.

The disclosure also provides support for a method for rewriting a resume such to be targeted to a job description, the method comprising: selecting an AI model from a plurality of publicly available AI models, the publicly available AI models including one or more large language models (LLM) and/or one or more natural language processing (NLP) models, instructing the AI model to assume a role of a hiring manager for a position included in the job description, providing the AI model instructions for performing the role of the hiring manager, submitting the resume and the job description to the AI model, and prompting the AI model to rewrite the resume based on the job description while performing the role of the hiring manager, prompting the AI model to provide a reasoning used by the AI model when rewriting the resume, generating a report including the rewritten resume and the reasoning, and displaying the report on a display device. In a first example of the method, the instructions for performing the role of the hiring manager include instructions to the AI model to generate a multi-step action plan for rewriting the resume prior to rewriting the resume. In a second example of the method, optionally including the first example, prompting the AI model to provide the reasoning used by the AI model when rewriting the resume further comprises prompting the AI model to provide the reasoning used by the AI model for each step of the plurality of steps of the multi-step action plan.

In another representation, an automated content generation system comprises a content generator including a processor communicably coupled to a non-transitory memory including instructions that when executed, cause the processor to receive a guideline text document and a first draft document, generate a second, targeted draft document targeted to the guideline text document based on the first draft document using a first plurality of artificial intelligence (AI) models, and display the targeted draft document on a display device of the AI system. For example, in a first embodiment, text content of a company is rewritten and/or reformatted by the automated content generation system to adhere to an internal style or branding guideline document of the company. In a second embodiment, editorial content of an article is rewritten by the automated content generation system to match an editorial style guidelines document. In a third embodiment, a formal report is rewritten by the automated content generation system to match a set of rules for generating the formal report. In other embodiments, the automated content generation system may rewrite drafts of text content to match content and/or style guidelines of other types of documents, such as product or instructional manuals, applications, requests for proposals (RFPs), or a different type of document.

Generating the second targeted draft document further may further comprise selecting an AI model of the first plurality of AI models, based on the first draft document and the guideline text document; inputting an element of the first draft document and the guideline text document into the AI model using chained prompts, to generate a respective targeted draft document element; and including the targeted draft document element in the targeted draft document. The quality of the targeted draft document element, using a second plurality of AI models, where in response to the quality exceeding a threshold quality, the targeted draft document element is included in the targeted draft document; and in response to the quality not exceeding the threshold quality, a different AI model of the first plurality of AI models is selected to rewrite the resume element. The second plurality of AI models may compete to assess the quality of the targeted draft document element against the original resume element in an adversarial fashion, with the quality being determined by a consensus between the second plurality of AI models. The first plurality of AI models may be different from the second plurality of AI models.

Additionally, the AI model may be prompted to generate a textual description of reasoning used by the AI model to generate the targeted element. The reasoning may be included in a report including the targeted draft document, which may be sent to a user and/or displayed on a display device of the automated content generation system. The report may include a keyword analysis of a portion and/or all of the targeted draft document, where the keyword analysis includes using the first plurality of AI models to extract a respective plurality of lists of keywords from the guideline text document; prompting each AI model of the first plurality of AI models to rank the list of keywords extracted by the AI model by order of importance; using the second plurality of AI models to validate the order of importance of each list of keywords; merging the list of keywords extracted by the first plurality of AI models to generate a validated, ranked keyword list; performing a keyword quality and density analysis of the portion and/or all of the targeted draft document based on the validated, ranked keyword list.

When introducing elements of various embodiments of the present disclosure, the articles “a,” “an,” and “the” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object. In addition, it should be understood that references to “one embodiment” or “an embodiment” of the present disclosure are not intended to be interpreted as excluding the existence of additional embodiments that also incorporate the recited features.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. An automated resume generation system, comprising:
a resume generator including a processor communicably coupled to a non-transitory memory including instructions that when executed, cause the processor to receive a job description and a first resume of an applicant for the job, generate a second, targeted resume for the job description based on the first resume using a first plurality of artificial intelligence (AI) models, and display the targeted resume on a display device of the AI system; wherein generating the second, targeted resume further comprises:
selecting an AI model of the first plurality of AI models, based on the first resume and the job description;
inputting an original resume element of the first resume and the job description into the AI model using chained prompts, to generate a respective targeted resume element; and
including the targeted resume element in the targeted resume.

2. The automated resume generation system of claim 1, wherein further instructions are stored in the non-transitory memory that when executed, cause the processor to assess a quality of the targeted resume element, using a second plurality of AI models;
in response to the quality exceeding a threshold quality, including the targeted resume element in the targeted resume; and
in response to the quality not exceeding the threshold quality, selecting a different AI model of the first plurality of AI models to rewrite the resume element.

3. The automated resume generation system of claim 2, wherein the second plurality of AI models compete to assess the quality of the targeted resume element against the original resume element in an adversarial fashion, with the quality being determined by a consensus between the second plurality of AI models.

4. The automated resume generation system of claim 2, wherein the first and second pluralities of AI models include at least one of:
internal AI models of the resume generator;
large language models (LLM) available via public AI services; and
natural language processing (NLP) models available via public AI services.

5. The automated resume generation system of claim 2, wherein the first plurality of AI models is different from the second plurality of AI models.

6. The automated resume generation system of claim 4, wherein the second, targeted resume includes a professional summary generated by an AI model of the first plurality of AI models, the professional summary based on the first resume and the job description.

7. The automated resume generation system of claim 1, wherein further instructions are included in the non-transitory memory that when executed, cause the processor to further prompt the AI model to generate a textual description of reasoning used by the AI model to generate the targeted element.

8. The automated resume generation system of claim 7, wherein further instructions are stored in the non-transitory memory that when executed, cause the processor to:
generate a report including the targeted resume and the textual description of the reasoning used by the AI model; and
display the report on a display device of the resume generation system and/or send the report to the applicant.

9. The automated resume generation system of claim 1, wherein the AI model of the first plurality of AI models is selected using an AI service optimization model based on at least one of:
the first resume;
a pricing of AI services including the AI models; and
a success rate of an AI model on similar types of resumes.

10. The automated resume generation system of claim 9, wherein the AI service optimization model includes a predictive machine learning (ML) model.

11. The automated resume generation system of claim 2, wherein further instructions are stored in the non-transitory memory that when executed, cause the processor to perform a keyword analysis of a portion and/or all of the targeted resume.

12. The automated resume generation system of claim 11, wherein the keyword analysis includes:
using the first plurality of AI models to extract a respective plurality of lists of keywords from the job description;
prompting each AI model of the first plurality of AI models to rank the list of keywords extracted by the AI model by order of importance;
using the second plurality of AI models to validate the order of importance of each list of keywords;
merging the list of keywords extracted by the first plurality of AI models to generate a validated, ranked keyword list;
performing a keyword quality and density analysis of the portion and/or all of the targeted resume based on the validated, ranked keyword list; and
storing a result of the keyword quality and density analysis in a memory of the resume generator and/or displaying the keyword quality and density analysis on a display device of the resume generation system.

13. A method for an automated resume generation system, the method comprising:
receiving a job description;
receiving a resume of an applicant for the job description;
storing individual resume elements of the received resume and job description in a database of the automated resume generation system;
submitting each stored individual resume element of the received resume to a selected AI model of a first plurality of AI models, to be rewritten to be tailored to the job description, the selected AI model selected based on the resume and the job description;
validating each rewritten individual resume element using a second plurality of AI models;
generating a targeted resume of the applicant based on the rewritten individual resume elements; and
displaying the targeted resume on a display device of the automated resume generation system and/or sending the targeted resume to the applicant.

14. The method of claim 13, further comprising submitting each stored individual resume element to the selected AI model in a sequence of chained prompts.

15. The method of claim 13, wherein validating each rewritten individual resume element using the second plurality of AI models further comprises:
submitting the rewritten individual resume element to each AI model of the second plurality of AI models, and prompting each AI model to answer an identical plurality of questions with Boolean responses;
in response to all of the second plurality of AI models returning true to all of the plurality of questions, including the rewritten individual resume element in the targeted resume; and
in response to any of the second plurality of AI models returning false to a question of the plurality of questions, discarding the rewritten individual resume element and submitting the stored individual resume element to a different AI model of the first plurality of AI models to rewrite the resume element.

16. The method of claim 13, wherein the targeted resume includes a professional summary generated by an AI model of the automated resume generation system, the professional summary targeted to the resume and the job description.

17. The method of claim 13, wherein displaying the targeted resume on the display device of the automated resume generation system and/or sending the targeted resume to the applicant further comprises including the targeted resume in a report, the report including a textual description of a reasoning used by the selected AI model, the textual description generated by the selected AI model.

18. A method for rewriting a resume such to be targeted to a job description, the method comprising:
selecting an AI model from a plurality of publicly available AI models, the publicly available AI models including one or more large language models (LLM) and/or one or more natural language processing (NLP) models;
instructing the AI model to assume a role of a hiring manager for a position included in the job description;
providing instructions to the AI model for performing the role of the hiring manager;
submitting the resume and the job description to the AI model, and prompting the AI model to rewrite the resume based on the job description while performing the role of the hiring manager;
prompting the AI model to provide a reasoning used by the AI model when rewriting the resume;
generating a report including the rewritten resume and the reasoning; and
displaying the report on a display device.

19. The method of claim 18, wherein the instructions for performing the role of the hiring manager include instructions to the AI model to generate a multi-step action plan for rewriting the resume prior to rewriting the resume.

20. The method of claim 19, wherein prompting the AI model to provide the reasoning used by the AI model when rewriting the resume further comprises prompting the AI model to provide the reasoning used by the AI model for each step of the multi-step action plan.
